(19) United States
(12) Patent Application Publication
(10) Pub. No.: US 2026/0169884 A1
(43) Pub. Date: Jun. 18, 2026

(54) SYSTEM FEEDBACK ANALYSIS INTEGRATION

(71) Applicant: International Business Machines Corporation, Armonk, NY (US)

(72) Inventors: PHILIP SICONOLFI, Massapequa, NY (US); Ann M DePaolo, LaGrangeville, NY (US); David F. Hans, Castleton, NY (US); Danielle Palumbo, North Babylon, NY (US); Kathleen Pfeiffer, Hurley, NY (US)

(73) Assignee: International Business Machines Corporation, Armonk, NY (US)

(21) Appl. No.: 18/985,627

(22) Filed: Dec. 18, 2024

(51) Int. Cl. G06F 11/34; G06F 8/65

(52) U.S. Cl. CPC G06F 11/3409; G06F 8/65

(57) ABSTRACT

An embodiment establishes a feedback database configured to transmit and store feedback data related to a platform. The embodiment analyzes the feedback data stored on the feedback database to identify a potential issue associated with the platform. The embodiment identifies a source of the potential issue. The embodiment analyzing a first impact of performing an update to a first component of the platform related to the source of the potential issue. The embodiment analyzes a second impact of performing an update to a second component of the platform related to the first component of the platform. The embodiment generates a first update recommendation to update the first component of the platform based on the first impact of performing the update to the first component and the second impact of performing the update to the second component. The embodiment performs the first update recommendation to update the first component.

### BACKGROUND

The present invention relates generally to system monitoring. More particularly, the present invention relates to a method, system, and computer program for automatic system feedback analysis integration.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries. Accordingly, AI systems may be designed for various tasks that traditional computer systems were previously incapable.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex. An ANN today might have upwards of billions of interconnected “neuron” processor units, though may be trained using a far fewer number of dedicated hardware processor units (e.g., GPUs). Further, ANNs can be designed to uncover relationships between previously unknown factors and accomplish tasks that were previously incapable by a human being alone.

Natural Language Processing (NLP) is a subfield of artificial intelligence aimed towards causing computers to comprehend, interpret, and generate human language in a contextually meaningful manner. NLP algorithms and models are engineered to process and scrutinize vast quantities of natural language data, encompassing text and speech, to extract insights, derive significance, and execute tasks that involve understanding human language. NLP encompasses a diverse array of tasks and applications, including but not limited to, text classification for assigning categories to text data, named entity recognition for identifying entities like names and locations, sentiment analysis for determining emotional tones in text and speech, machine translation for translating text between languages, text generation for creating human-like text, and question answering for generating responses to queries. NLP algorithms utilize methodologies from machine learning, deep learning, and linguistic analysis to comprehend and process human language data. These algorithms often require extensive datasets for training, such as text corpora, to learn patterns, relationships, and structures within language data. NLP is incorporated in various applications, such as search engines, virtual assistants, sentiment analysis tools, language translation services, and more.

### SUMMARY

The illustrative embodiments provide for a system and method for feedback analysis integration. An embodiment includes establishing a feedback database configured to transmit and store feedback data related to a platform, wherein the feedback data comprises data related to a performance metric corresponding to one or more components of the platform. The embodiment also includes analyzing the feedback data stored on the feedback database to identify a potential issue associated with the platform, wherein the potential issue is indicative of degradation of system performance. The embodiment also includes identifying a source of the potential issue associated with the platform. The embodiment also includes analyzing a first impact of performing an update to a first component of the platform related to the source of the potential issue. The embodiment also includes analyzing a second impact of performing an update to a second component of the platform related to the first component of the platform. The embodiment also includes generating a first update recommendation to update the first component of the platform based on a first result of analyzing the first impact of performing the update to the first component and a second result of analyzing the second impact of performing the update to the second component. The embodiment also includes performing, responsive to a determination that the first update recommendation comprises a non-disruptive impact to the second component, the first update recommendation to update the first component of the platform.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module for feedback analysis integrator in accordance with an illustrative embodiment;

FIG. 4 depicts a block diagram of an example system providing feedback analysis integration in accordance with an illustrative embodiment;

FIG. 5 depicts a block diagram of an example system for automatic feedback analysis integration in accordance with an illustrative embodiment;

FIG. 6 depicts a block diagram of an example system for automatic feedback analysis integration in accordance with an illustrative embodiment; and

FIG. 7 depicts a flowchart of an example process for providing for automatic feedback analysis integration in accordance with an illustrative embodiment.

### DETAILED DESCRIPTION

Organizations and systems often use feedback mechanisms to update components of a system and steer content development. Accordingly, collecting feedback data allows organizations to gather information about the performance of the system and make necessary adjustments to improve system effectiveness and efficiency. Feedback mechanisms typically include sensors or data collection tools that monitor various aspects of the system's performance, which may be configured to collect data on key performance indicators such as user engagement, content relevance, system responsiveness, and other relevant metrics.

Feedback also plays a crucial role in steering content development within and/or across a system. By analyzing user feedback and engagement metrics, organizations can gain insights into the type of content that resonates with users and drives desired outcomes. This information can then be used to inform content development strategies, such as creating new content, updating existing content, or personalizing content recommendations to better meet user needs.

Despite technological advancements in the field, currently existing feedback mechanisms are nevertheless deficient for various reasons. In some cases, the deficiencies of currently existing feedback mechanisms are due to their inability to identify the source of feedback, specifically the component of the system responsible for causing the digital experience a user has described in the feedback. This deficiency can hinder systems from effectively addressing issues and making targeted improvements to enhance the overall system development and user experience. Accordingly, existing feedback mechanisms may provide general insights into user satisfaction or dissatisfaction with the system but may not offer detailed information on the specific components or features that are causing the issues. Without this level of granularity, systems and organizations may struggle to identify the root cause of user feedback and take appropriate corrective actions.

Another aspect of currently existing feedback mechanisms contributing to this deficiency may include the absence of correlation analysis between feedback data and system components. Feedback data is often collected and analyzed in isolation, without being linked to specific components or functionalities of the system. This disconnect makes it challenging for systems and organizations to determine which component is responsible for the user experience described in the feedback. Without performing a correlation analysis, systems and/or organizations may resort to making broad, uninformed changes to the system, which can be inefficient and ineffective.

Another aspect of currently existing feedback mechanisms contributing to this deficiency may include a lack of system-wide visibility and interconnectedness. Existing feedback mechanisms may focus on individual components in isolation, without considering the interdependencies and interactions between different parts of the system. As a result, systems and/or organizations may struggle to predict how changes to one component will ripple through the system and impact other components. Embodiments of the present disclosure consider the impact of updates on the system as well as the individual components of that system. By adopting a holistic view of the system and understanding the interconnectedness of its parts, systems and/or organizations can better anticipate how updating one component may affect the functionality of others.

An embodiment of the present disclosure includes identifying a first component of a system to update based on user feedback. An embodiment includes identifying a second component based on a relation of the first component and the second component. In some cases, the second component may not have been identified by the user feedback. In an embodiment, the system initiates an update for both the first component and the second component. This configuration advantageously leverages the interdependencies between system components to proactively improve related areas and enhance the overall system performance. By identifying and updating related components in tandem, the system can ensure that changes made to one component do not inadvertently disrupt the functionality of interconnected components. This proactive approach minimizes the risk of introducing new issues while addressing existing issues, leading to a more stable and reliable system.

An embodiment of the present disclosure includes performing system updates across multiple components simultaneously. By recognizing the relationships between components and updating them in a coordinated manner, the system can achieve synergistic improvements that enhance overall system functionality. This holistic approach to updates ensures that the system evolves cohesively, rather than in isolated silos, resulting in a more integrated and seamless content development and user experience. Furthermore, by leveraging dependency mapping to identify related components for updates, the system can streamline the update process and reduce manual intervention. Performing system updates across multiple components simultaneously not only accelerates the update cycle but also frees up resources that would otherwise be spent on identifying and prioritizing components for improvement. As a result, systems can iterate on system enhancements more efficiently and respond promptly to user feedback and evolving requirements.

An embodiment of the present disclosure includes a scheduling mechanism to prioritize updates, establish an update queue, and/or reprioritize the update queue based on continuously collected feedback. This configuration optimizes the update process by dynamically adjusting the order and timing of updates to align with user feedback and system requirements effectively. In an embodiment, the system prioritizes updates based on predefined criteria, such as the severity of issues identified in user feedback, the impact on system performance, or any other user defined objective objectives. By assigning priorities to update tasks, the system can ensure that more critical issues are addressed promptly and that updates are aligned with predefined goals and/or user needs.

In an embodiment, the scheduling mechanism establishes an update queue that sequences update tasks based on their priority levels. Furthermore, the scheduling mechanism continuously collects feedback data from various sources, such as user interactions, feedback channels, and system performance metrics. By analyzing this feedback data in real-time, the mechanism can dynamically reprioritize the update queue based on the most recent user feedback and system insights. This continuous feedback loop enables the system to adapt to changing user preferences, emerging issues, and evolving requirements, ensuring that updates remain aligned with user expectations and business objectives.

In an embodiment, the scheduling mechanism considers dependencies of components when scheduling updates to ensure that updates are executed in a logical sequence that takes into account the interrelationships between different system components. By considering dependencies, the scheduling mechanism can prevent conflicts, minimize disruptions, and optimize the efficiency of the update process. In an embodiment, when scheduling updates, the mechanism identifies the dependencies between system components by analyzing the relationships and interactions between the component. Once dependencies are identified, the scheduling mechanism organizes the update queue based on these dependencies. In some embodiments, updates to components with no dependencies or with dependencies that have already been updated can be scheduled ahead of components with dependencies. Subsequently, updates to components with dependencies that have not yet been updated are scheduled in a sequence that ensures that dependent components are updated after their dependencies. In an embodiment, the scheduling mechanism may utilize dependency graphs or directed acyclic graphs (DAGs) to visualize and manage component dependencies. These graphs represent the relationships between components and their dependencies in a structured format, allowing the mechanism to determine the optimal order for scheduling updates.

Embodiments of the present disclosure leverage one or more machine learning algorithms and decision-making frameworks to enable the system to learn and suggest updates to components of a platform based on collected feedback. For example, embodiments of the present disclosure may include one or more NLP techniques, such as sentiment analysis, topic modeling, named entity recognition, and/or text summarization to effectively analyze user feedback data to identify areas for improvement across the platform. Accordingly, one or more NLP algorithms may be used to link the feedback to the corresponding components of the system that a user is referring to, providing clarity on which parts of the system are being discussed in the feedback. For example, a text analysis algorithm may be employed to analyze the language used in the feedback to extract key phrases, terms, or context that provide insights into the components being referenced. By examining the text data, NLP algorithms can identify keywords or phrases that indicate which parts of the system are being discussed, enabling the system to map the feedback to the relevant components accurately.

Accordingly, the present disclosure addresses the deficiencies described above by providing a process (as well as a system, method, machine-readable medium, etc.) that develops a feedback analysis integration system. Embodiments of the present disclosure include collecting and analyzing feedback data to identify areas that may require updating within a platform or system. This updating may include, but is not limited, modifying algorithms, adjusting content recommendations, optimizing user interfaces, or making other changes to enhance the overall performance of the platform/system. By continuously updating and refining components based on feedback, updates to the platform/system are performed efficiently and may be coordinated in consideration of interdependencies between components of the platform/system.

In an embodiment, feedback analysis integration system includes a feedback analysis integrator configured to collect and analyze feedback data and generate an update recommendation based on results of analyzing the impact of the update one or more components of the system. In an embodiment, the system may include one or more deep learning mechanisms. For example, at least one deep learning mechanism may be configured to identify components of a system based on system feedback. In an embodiment, training the model(s) may include a supervised learning technique, an unsupervised learning technique, a human-in-the-loop, training technique, and/or any combination thereof. In an embodiment, the deep learning mechanism may include elements of an RNN, GAN, LTSM, Transformer, and/or any combination thereof.

In an embodiment, one or more deep learning algorithms may be trained to learn patterns and relationships from historical data to make informed decisions about update recommendations. In an embodiment, one or more deep learning algorithms may be trained to to predict an impact that a modification to a component of a system may have to another component of the system. Further, one or more deep learning algorithms may be trained to generate an update recommendation that considers impact of an update to one or more components of a system. In an embodiment, one or more deep learning algorithms may be trained to schedule system updates. In an embodiment, at least one deep learning mechanism may be configured, trained, fine-tuned, tailored, optimized, etc. to meet a user defined objective when generating, scheduling, and/or performing recommended updates to components. In an embodiment, the system includes an optimization mechanism. The optimization mechanism may be configured to set the goals for the system, which may include, for example, executing an update schedule that minimizes total consumption of resources to execute.

The illustrative embodiments provide for a feedback analysis integrator. As used throughout the present disclosure, the term “feedback” or “feedback data” refers to information, opinions, and/or responses provided by a user, a system, and/or a user interacting with a system that conveys an experience, perception, or evaluation of a system component, product, service, process, or the like associated with the system. Embodiments of the present disclosure consider leveraging “user feedback” as well as “system feedback.” User feedback may include, but is not limited to, inputs, comments, reviews, forum posts, surveys, and other forms of direct communication from a user regarding their experiences with a system, component, product or service. User feedback may provide qualitative insights into user preferences, satisfaction levels, pain points, and suggestions for improvement. Further, embodiments may analyze user feedback to identify areas for enhancement, prioritize feature development, and tailor offerings to better meet user expectations. Examples of system feedback may include, but are not limited to, performance metrics, workflow monitoring data, interaction assessments, and other quantitative indicators that reflect the user interaction, operational efficiency and/or effectiveness of a system. System feedback provides objective measurements of system performance, user interactions, and workflow processes. By monitoring system feedback, embodiments can track key performance indicators, identify bottlenecks or inefficiencies, and optimize system functionality.

As used throughout the present disclosure, the term “platform” refers to a software and/or or hardware environment that serves as an infrastructure for running applications, services, or other related technologies. A platform may provide a set of tools, resources, and services that enable developers to build, deploy, and manage software applications or systems. Platforms typically include operating systems, programming languages, libraries, frameworks, and APIs that facilitate the development and execution of different software applications and/or services. Example types of platforms may include, but are not limited to, operating systems platforms, cloud computing platforms, development platforms, and application platforms. In an embodiment, the platform may be tailored to specific use cases and requirements. In some embodiments, the platform may include separate disparate content development repositories corresponding to different components of the platform.

In an embodiment, the feedback analysis integrator can be integrated into the platform to monitor the development process by analyzing feedback, code repositories, version control systems, and development workflows. Embodiments include tracking changes, updates, and modifications made to the platform's codebase, architecture, or features, and considering real-time feedback on the impact of these changes on system performance and user experience. In an embodiment, the feedback analysis integrator can monitor user interactions within the platform to gather insights on user behavior, preferences, and feedback. By analyzing user queries, responses, and actions, the integrator can identify patterns and trends that inform the development of the system. In an embodiment, the feedback analysis integrator can provide recommendations, suggestions, or alerts to the system, developers and/or stakeholders on how to improve user experiences, address potential issues, and enhance the platform's functionality in a coordinated, holistic manner.

Illustrative embodiments include establishing a feedback database, the feedback database configured to transmit and store feedback data related to a platform. The embodiment also includes analyzing the feedback data stored on the feedback database to identify a potential issue associated with the platform. The embodiment also includes identifying a source of the potential issue associated with the platform. The embodiment also includes analyzing an impact of performing an update to a first component of the platform related to the source of the potential issue identified. The embodiment also includes analyzing an impact of performing an update to a second component of the platform related to the first component of the platform. The embodiment also includes generating a first update recommendation to update the first component of the platform based on results of analyzing the impact of performing the update to the first component and results of analyzing the impact of performing the update to the second component. The embodiment also includes performing the first update recommendation to update the first component of the platform.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

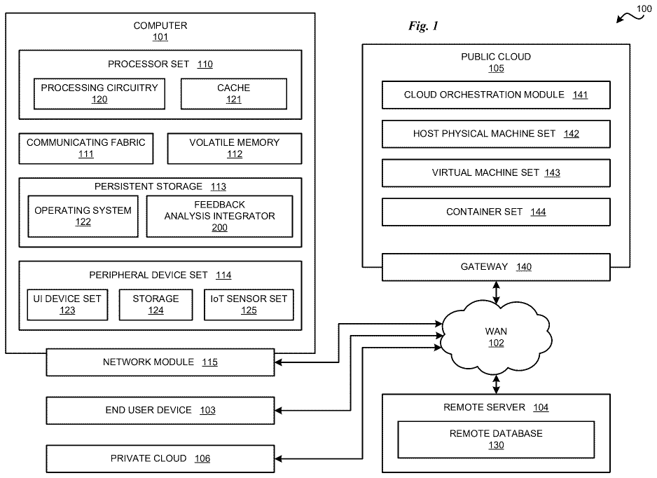

With reference to FIG. 1, this figure depicts a block diagram of a computing environment 100. Computing environment 100 contains an example of an environment for the execution of at least some of the computer code involved in performing the inventive methods, such as feedback analysis integrator 200 configured to analyze impact of integrating updates based on feedback received from a system. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

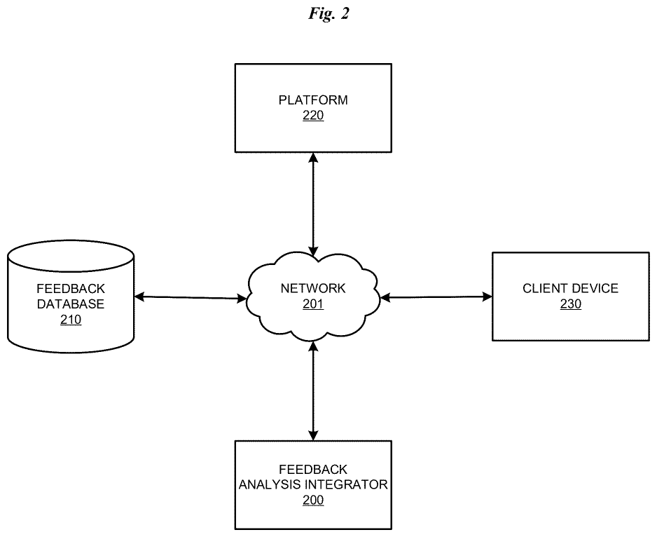

With reference to FIG. 2, this figure depicts a block diagram of an example computing environment in accordance with an illustrative embodiment. In the illustrated embodiment, the computing environment includes the feedback analysis integrator 200 of FIG. 1. In an embodiment, components of the depicted computing environment provide a system configured to aggregate feedback data and analyze the aggregated feedback data to generate component-specific update recommendations to guide development decision-making of a particular platform. In an embodiment, feedback analysis integrator 200, feedback database 210, platform 220, and client device 230 may all communicate with each other over any suitable network 201 (e.g., the Internet).

In the illustrated embodiment, feedback analysis integrator 200 analyzes feedback data stored on feedback database 210 to generate one or more update recommendations to update one or more components of platform 220. In an embodiment, the feedback analysis integrator 200 orchestrates the aggregation and analysis of feedback data. In an embodiment, feedback analysis integrator 200 collects feedback data from various sources, including but not limited to, user interactions, surveys, reviews, social media, forums, websites, etc., and consolidates this data into a unified dataset for analysis. In some embodiments, the integrator 200 may utilize one or more Natural Language Processing (NLP) algorithms, machine learning models, and data analysis techniques to extract insights, patterns, and sentiments from the feedback data, as described in greater detail herein. By processing the aggregated feedback data, the integrator 200 generates component-specific update recommendations based on the identified areas for improvement and user preferences.

In the illustrated embodiment, feedback database 210 functions as a repository where feedback data is stored and managed. In an embodiment, the feedback database 210 stores a combination of raw feedback entries, processed data, analysis results, and update recommendations generated by the feedback analysis integrator 200. The feedback database 210 enables efficient data retrieval, querying, and storage of feedback information, ensuring that historical feedback data is accessible for analysis and decision-making. By maintaining a centralized feedback database, the system can track feedback trends over time, monitor changes in user sentiment, and facilitate continuous improvement efforts based on historical feedback insights.

In an embodiment, the feedback database 210 includes one or more mechanisms to retrieve data from a variety of feedback data sources. Examples of feedback data sources may include, but are not limited to, surveys, reviews, blogs, forums, social media, websites, printed publications, and the like. In an embodiment, the feedback database 210 may include a data storage data schema to configured to provide structured storage to manage different types of feedback data (e.g., types, topics, sentiment, relevance, etc.)

In an embodiment, platform 220 includes a particular system or application for which feedback is being collected and analyzed. In some embodiments, the platform 220 may include aspects of a software platform, a website, a mobile application, and/or any digital product or service that interacts with users. In an embodiment, the platform 220 integrates with the feedback analysis integrator 200 and feedback database 210 to receive component-specific update recommendations derived from the analysis of feedback data. In some embodiments, development decisions and feature updates are guided by the insights and recommendations provided by the feedback analysis integrator 200.

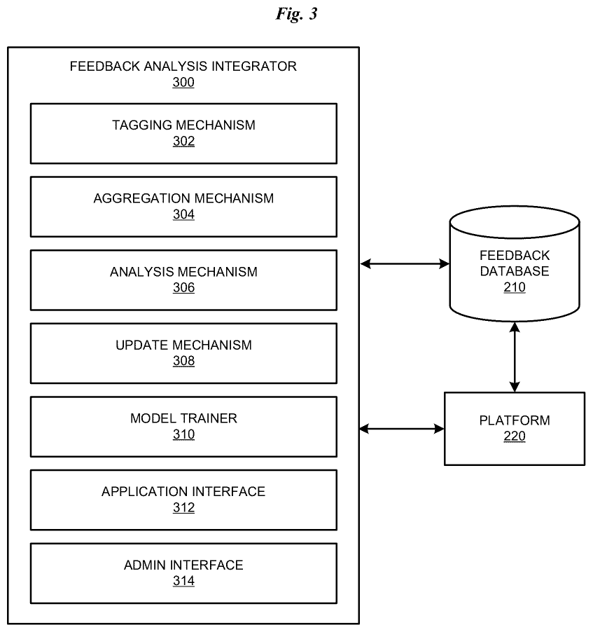

With reference to FIG. 3, this figure depicts a block diagram of an example feedback analysis integrator. In the illustrated embodiment, the feedback analysis integrator 300 includes feedback analysis integrator of FIG. 2. In some embodiments, feedback analysis integrator 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the feedback analysis integrator 300 may include a combination of physical and virtualized components, as well as may be partially or entirely virtualized on a virtual machine.

In the illustrated embodiment, feedback analysis integrator 300 is a software module including a plurality of other software modules, including an tagging mechanism 302, an aggregation mechanism module 304, an analysis mechanism module 306, an update mechanism module 308, a model trainer module 310, an application interface module 312, and an administrator module 314.

In the illustrated embodiment, the tagging mechanism 302 includes a software module configured to label incoming feedback data based on predefined criteria. In an embodiment, the tagging mechanism module 302 assigns tags or labels to feedback entries to classify them according to defined attribute, which may include, but are not limited to, sentiment, topic, user demographics, etc. By tagging feedback data, the feedback analysis integrator 300 can organize and structure the information for further analysis and processing.

In the illustrated embodiment, the aggregation mechanism module 304 includes a software module configured to collect and consolidate tagged feedback data from various sources into a centralized repository, such as feedback database 210. In an embodiment, aggregation mechanism module 304 aggregates feedback entries from different channels or sources, such as surveys, social media, or customer support tickets, to create a comprehensive dataset for analysis. By aggregating feedback data, the feedback analysis integrator 300 can gain a holistic view of platform 220 and user experiences across multiple touchpoints.

In the illustrated embodiment, the analysis mechanism module 306 processes the aggregated feedback data to extract insights, trends, and patterns within the aggregated feedback data related to platform 220. In an embodiment, analysis mechanism module 306 employs one or more data analysis techniques, such as sentiment analysis, text mining, or machine learning algorithms, to uncover relationships between information from the feedback dataset. By analyzing feedback data, the feedback analysis integrator 300 can identify common themes, issues, and opportunities for content development or component/feature improvement.

In an embodiment, analysis mechanism module 306 is configured to identify one or more components of the platform 220 related to the feedback data. In an embodiment, analysis mechanism module 306 may employ sentiment analysis, which may include analyzing the emotional tone and attitude expressed in the feedback data. By applying sentiment analysis algorithms, the analysis mechanism module 306 can identify components of the platform 220 that are frequently mentioned in positive or negative contexts. In some embodiments, components that receive consistent positive feedback may be deemed successful, while those associated with negative sentiments may prompt recommendations for further investigation and/or updates.

In an embodiment, analysis mechanism module 306 is configured to identify a first component related to feedback data that requires updating and a second component related to the first component that would be affected by the update. An embodiment includes analyzing the relationships between system components of platform 220 and feedback data to determine which components are interconnected and how updates to one component may impact others. An embodiment assesses the relationships between the first component and other system components to determine potential dependencies or impacts. By examining the interconnectedness of system components through data analysis and modeling, the module can predict which other components are likely to be affected by updates to the first component. This analysis helps identify the second component that is related to the first component and would be influenced by the update. In an embodiment, the analysis mechanism module 306 utilizes one or more machine learning algorithms to predict the effects of updating the first component on other related components.

In an embodiment, the analysis mechanism module 306 is configured to monitor, track, and/or analyze user interactions with platform 220. In an embodiment, the analysis mechanism module 306 collects data on user actions, inputs, queries, etc. during an interaction session with platform 220, and contextual information during interactions. This data may be used to evaluate the context of the interactions improve to ability to identify components of platform 220 that may be suggested for updating based on user feedback. analysis mechanism module 306 collects and analyzes workflow data to identify components to update based on user interaction data in conjunction with feedback data. This process involves integrating user interaction data, such as user behavior patterns, system usage metrics, and workflow information, with feedback data to gain a comprehensive understanding of user experiences and system performance. The analysis mechanism module 306 first collects workflow data, which includes information on how users interact with the system, navigate through different components, and perform tasks. This data may encompass user clicks, navigation paths, time spent on specific features, and other interaction metrics. By capturing workflow data, the module can track user behaviors and identify areas of the system that are frequently accessed or encountered by users.

In an embodiment, the analysis mechanism module 306 analyzes the workflow data in conjunction with feedback data, which includes user feedback directly received from the system. This feedback data may consist of user comments, ratings, surveys, and other forms of direct user input regarding their experiences with the system. By combining workflow data with feedback data, the module can correlate user interactions with user sentiments and preferences, providing a more holistic view of user experiences. In an embodiment, the analysis mechanism module 306 employs one or more data analysis techniques to identify components to update based on the integrated workflow and feedback data. By analyzing user interaction patterns, sentiment trends, and system performance metrics, the module can identify components that may be suggested for updating. This analysis helps prioritize updates to components that have a significant impact on user experiences and system usability.

In an embodiment, analysis mechanism module 306 is configured to collect real-time user sentiments and reactions to system changes or updates. In an embodiment, analysis mechanism module 306 continuously monitors user feedback and adjusts update priorities based on feedback in response to updates or changes to the system. By integrating feedback data from multiple sources, including direct user input, the module can ensure that update decisions are informed by a comprehensive understanding of user needs and preferences.

In an embodiment, analysis mechanism module 306 constructs a dependency map between components of a system to analyze the impact of component updates based on feedback. This process may include mapping out the relationships and dependencies between system components to understand how changes to one component may affect others, enabling the system to assess the potential impact of updates on the overall system functionality.

In an embodiment, the analysis mechanism module 306 identifies the various components of platform 220 and establishes the connections and dependencies between the component. In an embodiment, determining connections and dependencies between components may be based in part on results of analyzing the interactions, data flows, and functionalities of each component to determine how they are interconnected within the system architecture. By mapping out these dependencies, the analysis mechanism module 306 enables feedback analysis integrator 300 to creates a visual representation of the relationships between components.

In an embodiment, analysis mechanism module 306 incorporates feedback data into the dependency map to understand how user input and sentiments are linked to specific system components. By correlating feedback data with the identified components in the dependency map, the analysis mechanism module 306 can identify which components are most frequently mentioned in user feedback, indicating areas that may require attention or updates. Further, once the dependency map is constructed and feedback data is integrated, the analysis mechanism module 306 can analyze the impact of component updates on the system. By simulating changes to one component and tracing how these updates propagate through the dependency map to affect other connected components, the analysis mechanism module 306 can predict the potential consequences of updates on system performance, user experience, and overall functionality.

In an embodiment, the update mechanism module 308 generates one or more update recommendations to update one or more components of platform 220. In an embodiment, the update mechanism module 308 generates a first update recommendation to update a first component of the platform 220. In an embodiment, generating the first update recommendation to update the first component of the platform is based at least in part on results of analyzing the impact of performing the update to the first component and results of analyzing the impact of performing the update to a second component related to the first component. In an embodiment, the update mechanism module 308 performs an update to one or more components of platform 220 based on the generated update recommendation.

In an embodiment, the model trainer mechanism module 310 includes a software module configured to train one or more machine learning models described herein. By training models on historical system data and feedback information, the model trainer mechanism module 310 can simulate the potential outcomes of updating the first component and assess how these changes may propagate through the platform 220. This predictive analysis enables the analysis mechanism module 306 to anticipate which components of platform 220 are most vulnerable to the update and need to be considered in the update process.

In an embodiment, the model trainer module 310 is configured to train one or more machine learning algorithms and predictive modeling techniques to predict the cascading effects of component updates on platform 220. By training models on historical system data and feedback information, the model trainer module 310 can simulate different update scenarios and evaluate the implications of each change on the system as a whole. This predictive analysis enables embodiments to make informed decisions about update priorities and strategies based on the expected impact on system components.

In an embodiment, the application interface module 312 serves as the interface through which users and/or applications interact with feedback analysis integrator 300 and facilitates the exchange of information between the users and/or applications and the feedback analysis integrator 300. In an embodiment, the application interface module 312 is configured to interact with any or all other modules within feedback analysis integrator 300 to relay user input, queries, user feedback, and system feedback. In some embodiments, feedback anaylsis integrator 300 connects with API gateway via any suitable network 201 or combination of networks such as the Internet, etc. and uses any suitable communication protocols such as Wi-Fi, Bluetooth, etc. to connect to platform 220 to feedback analysis integrator 300 and/or feedback database 210. The API gateway may transmit service requests received from a client interacting with platform 220.

In an embodiment, the administrator module 314 includes a user interface configured to allow a user having sufficient privileges to oversee the operation and management of feedback analysis integrator 300. In an embodiment, administrator module 314 controls access permissions, monitors system performance, and handles any administrative tasks related to the platform. In an embodiment, the administrator module 314 interacts with any or all other modules. A backend administration system allows users with administrative privileges to perform various administrative tasks associated with feedback analysis integrator 300 as described herein, such as initiating a data collection and/or correlation process, a neural network training process, defining optimization goals, defining execution parameters/criteria, performing an update, and any other defined settings discussed herein. In an embodiment, administrator module 314 provides a visual representation of update recommendations generated by feedback analysis integrator 300. In some embodiments, the visual representation manifests in the form of a virtual graphical element based heatmap representing update recommendations according to priority in consideration of component dependencies and/or component relatedeness across the platform 220.

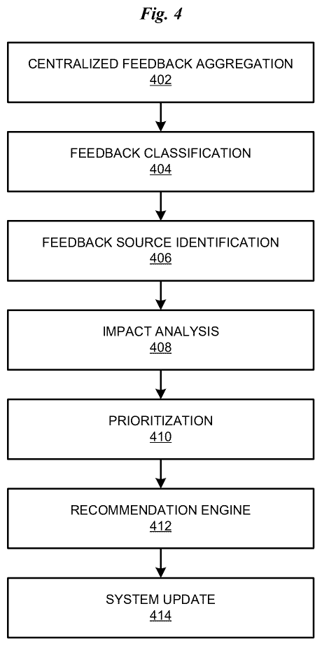

With reference to FIG. 4, this figure depicts a block diagram of an example system for feedback analysis integration in accordance with an illustrative embodiment. In the illustrative embodiment, block 402 includes collecting feedback data from various sources and consolidating the collected feedback data into a centralized repository. In some embodiments, block 402 aggregates feedback from user interactions, surveys, reviews, and other channels to create a unified dataset for analysis. By centralizing feedback data, this block ensures that all feedback is captured and organized in a structured manner for further processing and analysis.

In the illustrated embodiment, block 404 includes categorizing and labeling feedback data based on predefined criteria. In some embodiments, block 402 classifies feedback data into different categories or topics to facilitate analysis and interpretation. By applying classification algorithms, block 404 categorizes feedback into meaningful groups, aiding to identify common themes, issues, or sentiments expressed by users.

In the illustrated embodiment, block 406 includes identifying the sources of feedback data. In some embodiments, block 406 determines which component(s) of a platform are being referenced in the feedback data. In some embodiments, block 406 includes identifying the source of a potential issue referenced in the feedback data.

In the illustrated embodiment, block 408 includes conducting an impact analysis on updating a component to address the source of the potential issue identified in the feedback data. In some embodiments, block 408 evaluates the potential effects and consequences of updating the component in response to the issue identified in the feedback. By analyzing the impact of the proposed update on the system's performance, functionality, user experience, and/or other components of the system, block 408 assesses the implications of the change and ensures that the update will effectively address the identified issue without causing unintended disruptions or negative consequences.

In the illustrated embodiment, block 410 includes prioritizing feedback-based updates and reprioritizing the updates as needed. In some embodiments, block 406 determines the order in which updates should be implemented based on the significance of feedback data, system requirements, and component dependencies and interdependencies.

In the illustrated embodiment, block 412 includes generating recommendations for system updates based on the analysis of feedback data. In some embodiments, block 412 leverages insights from feedback aggregation, classification, and impact analysis to provide actionable recommendations for updating one or more system components.

In the illustrated embodiment, block 414 includes performing the recommended updates to the system components based on the feedback analysis. Performing the recommended updates to the system components may include changes, enhancements, or optimizations identified through the feedback processing stages. By applying the recommended updates, this block ensures that the system evolves in response to insight data-driven feedback, driving continuous improvement and enhancing the overall user experience and functionality of the system.

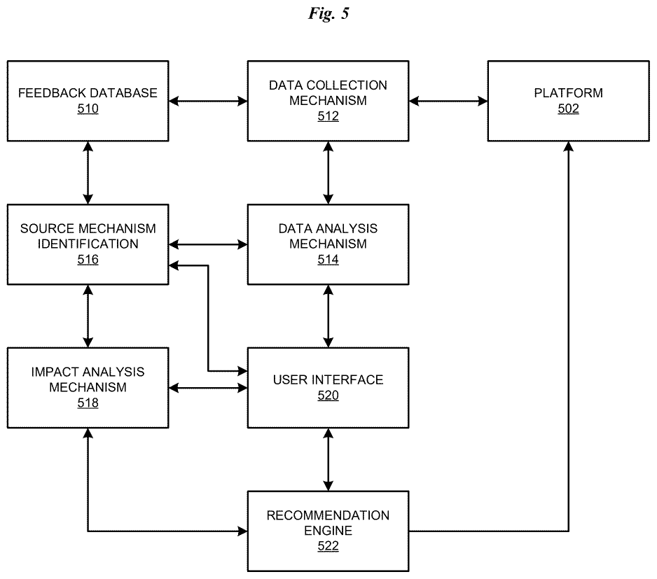

With reference to FIG. 5, this figure depicts an example system for automatic feedback analysis integration in accordance with an illustrative embodiment. In an embodiment, the system includes various mechanisms configured to collect, analyze, and/or derive insights from feedback data corresponding to a platform. In the illustrated embodiment, one or more data collection mechanisms 512 collect feedback data from platform 502 and store the feedback data on feedback database 510.

In the illustrated embodiment, data analysis mechanism 514 receives feedback data from data collection mechanism 512, as well as source-identification data defining sources (e.g., components) corresponding to potential issues identified in the feedback data. Accordingly, the source identification mechanism 516 may be configured to identify a source of potential issue contained within feedback data. In the illustrated embodiment, impact analysis mechanism 518 predicts the impact of performing an update on one or more components identified by the source identification mechanism 516. In the illustrated embodiment, the recommendation engine 522 generates one or more update recommendations based on the results of impact analysis mechanism 518. In the illustrated embodiment, the recommendation engine 522 is configured to perform an update to platform 502.

In the illustrated embodiment, user interface 520 includes a user interface configured to enable a user having sufficient privileges to visualize components of platform 502. In some embodiments, the visualization manifests in the form of a virtual graphical element based heatmap representing update recommendations according to priority in consideration of component dependencies and/or component relatedeness across the platform 220.

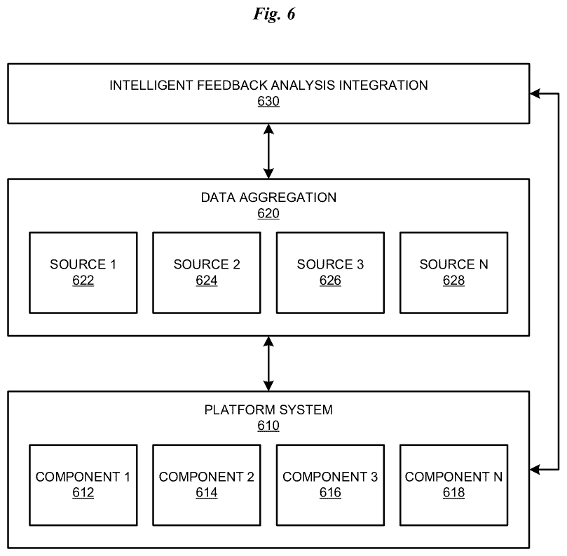

With reference to FIG. 6, this figure depicts a block diagram of an example system for automatic feedback analysis integration in accordance with an illustrative embodiment. In the illustrated embodiment, the system includes a platform system layer 610 in communication with a data aggregation layer 620, and an intelligent feedback analysis integration layer 630 in communication with the data aggregation layer 620 and the platform system layer 610. In some embodiments, one or more aspects of the system comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the system may include a combination of physical and virtualized components, as well as may be partially or entirely virtualized on a virtual machine.

The present disclosure acknowledges that a currently existing deficiency of current feedback-based update mechanisms is the lack of a centralized hub layer that makes associations between different product development repositories. This deficiency results in fragmented feedback data and disjointed update processes, making it challenging for system organizations to correlate feedback from various sources and coordinate updates across different repositories of a system effectively. The example configuration depicted by FIG. 6 address this deficiency by providing an feedback analysis integrator that serves as a hub layer connecting different product development repositories in order to create a unifying platform that bridges the gap between disparate repositories, facilitates data integration and analysis, and enables organizations to make informed decisions about system updates based on a comprehensive understanding of feedback data from across the system.

In the illustrated embodiment, platform system layer 610 serves as the interface through which users interact with the system, providing access to the platform's features and functionalities. Users can submit feedback, access system components, and engage with the platform's services through this layer. In the illustrated embodiment, platform system layer 610 includes a plurality of components, including a first component 612, a second component 614, a third component 616, and an nth component 618, collectively representing components of a platform. The platform system layer 610 acts as the front-end of the system, offering an interface for users to provide feedback and/or interact with the platform's components and features.

In the illustrated embodiment, the data aggregation layer 620 is configured for collecting, consolidating, and storing feedback data from various sources. In an embodiment, the data aggregation layer 620 aggregates feedback from user interactions, surveys, reviews, and other channels into a centralized repository for analysis. The data aggregation layer 620 ensures that feedback data is organized, structured, and readily accessible for further processing and analysis by the system. In the illustrated embodiment, data aggregation layer 620 includes data stored from a plurality of feedback data sources, including a first source 622, a second source 624, a third source 626, and an nth source 628, collectively representing sources of feedback related to the platform and/or platform feedback data.

In the illustrated embodiment, the intelligent feedback analysis integration layer 620 processes and analyzes feedback data to derive insights and generate actionable recommendations. In an embodiment, the feedback analysis integration layer 630 leverages one or more NLP algorithms, machine learning models, and data analysis techniques to extract information from the aggregated feedback data. By integrating with both the data aggregation layer and the platform system layer, the intelligent feedback analysis integration layer facilitates the seamless flow of feedback data, analysis results, and recommendations between the different system components. Accordingly, the intelligent feedback analysis integration layer 630 may aid in interpreting user feedback, identifying areas for improvement, and guiding decision-making to update the platform's components based on user and/or system feedback.

The depicted integrator system collects feedback data from diverse sources, such as user interactions, feedback channels, and system performance metrics, and aggregates this data into a unified dataset. By consolidating feedback data from multiple repositories, the integrator system creates a centralized hub that harmonizes feedback information and facilitates cross-repository analysis. Furthermore, the analysis mechanism module leverages data analysis techniques to identify relationships between feedback data and system components across different repositories. By constructing dependency maps, correlating feedback with system components, and analyzing workflow data, the system can establish connections between disparate repositories and understand how updates in one repository may impact components in another. This integrated approach enables a holistic approach to content development of a platform and prioritizes updates based on cross-repository dependencies.

In an embodiment, the analysis integrator includes an application interface module that provides an interface for stakeholders to interact with the centralized hub layer. This interface allows users to input feedback data, view analysis results, access update recommendations, and collaborate on update strategies across different repositories. In some embodiments, the interface includes visual representation that manifests in the form of a virtual graphical element based heatmap representing update recommendations according to priority in consideration of component dependencies and/or component relatedeness across the platform.

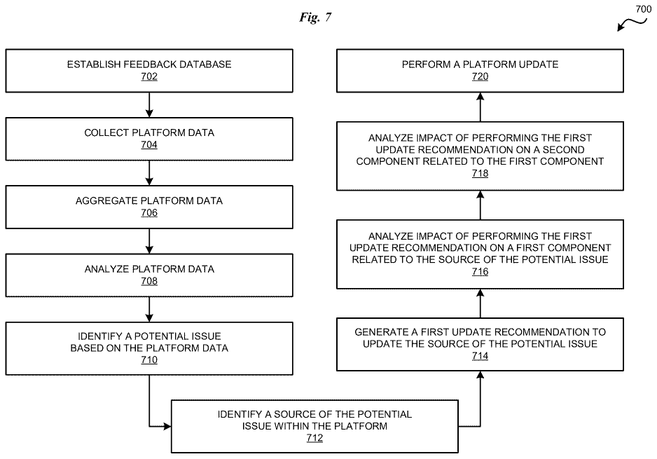

With reference to FIG. 7, this figure depicts a flowchart of an example process for providing ethical virtual assistance in accordance with an illustrative embodiment. In an embodiment, the feedback analysis integrator 200 of FIGS. 1 and 2 and/or the feedback analysis integrator 300 of FIG. 3 carries out the process 700.

In an embodiment, at step 702, the process establishes a feedback database. In an embodiment, the feedback database is configured to transmit and store feedback data related to a platform. In an embodiment, at step 704, the process collects feedback data from a platform. In an embodiment, the feedback data comprises data related to a performance metric corresponding to one or more components of the platform. In an embodiment, performance metric may include a metric capturing system performance, user experience, user interaction with a system, user interactions between users of a system, and so forth. and In an embodiment, at step 706, the process aggregates the feedback data collected and stores the aggregated feedback data on the feedback database.

In an embodiment, at step 708, the process analyzes the feedback data stored on the feedback database to identify a potential issue associated with the platform. In an embodiment, the potential issue is indicative of degradation of system performance. For example, degradation of system performance may include, but is not limited to, decreased response time, decreased user interaction, decreased click-through rate, decreased user interaction, decreased user satisfaction, and so forth. Further, although the term “degradation” is used, it is understood that a degradation of system performance may likewise include any undesired, unmet, and/or negative digital experience, as described in greater detail herein. In an embodiment, at step 710, the process identifies a source of the potential issue associated with the platform. In an embodiment, at step 712, the process identifies a source of the potential issue within the platform. In an embodiment, at step 714, the process generates a first update recommendation to update the source of the potential issue.

In an embodiment, at step 716, the process analyzes an impact of performing the first update recommendation to a first component of the platform related to the source of the potential issue identified. In an embodiment, at step 718, the process analyzes an impact of performing the first update recommendation to a second component of the platform related to the first component of the platform. In an embodiment, at step 720, the process performs the first update recommendation to update the first component of the platform based on results of the analyses. In an embodiment, the process includes performs the first update recommendation to update the first component of the platform responsive to a determination that the first update recommendation comprises a non-disruptive impact to the second component.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing a feedback database configured to transmit and store feedback data related to a platform, wherein the feedback data comprises data related to a performance metric corresponding to one or more components of the platform;
analyzing the feedback data stored on the feedback database to identify a potential issue associated with the platform, wherein the potential issue is indicative of degradation of system performance;
identifying a source of the potential issue associated with the platform;
analyzing a first impact of performing an update to a first component of the platform related to the source of the potential issue;
analyzing a second impact of performing an update to a second component of the platform related to the first component of the platform;
generating a first update recommendation to update the first component of the platform based on a first result of analyzing the first impact of performing the update to the first component and a second result of analyzing the second impact of performing the update to the second component; and
performing, responsive to a determination that the first update recommendation comprises a non-disruptive impact to the second component, the first update recommendation to update the first component of the platform.

2. The computer-implemented method of claim 1, further comprising:
generating a second update recommendation to update the second component of the platform based on results of analyzing the first impact of performing the update to the first component and results of analyzing the second impact of performing the update to the second component; and
performing the first second update recommendation to update the second component of the platform.

3. The computer-implemented method of claim 1, further comprising constructing a dependency mapping between a set of components of the platform, the dependency mapping defining a relationship between the first component and the second component.

4. The computer-implemented method of claim 1, wherein the feedback data comprises user feedback data.

5. The computer-implemented method of claim 1, wherein the feedback data comprises system feedback data.

6. The computer-implemented method of claim 1, further comprising aggregating feedback data collected from a plurality of disparate development repositories corresponding to the platform.

7. The computer-implemented method of claim 1, further comprising aggregating feedback data collected from a plurality of disparate development repositories corresponding to the platform.

8. The computer-implemented method of claim 1, further comprising tagging the feedback data collected from the platform to identify a set of relationships between feedback data and a set of components of the platform related to the feedback data.

9. The computer-implemented method of claim 1, further comprising training a machine learning model to predict impacts of update recommendations to a set of components of the platform.

10. A computer program product comprising one or more computer readable storage media, and program instructions collectively stored on the one or more computer readable storage media, the program instructions executable by a processor to cause the processor to perform operations comprising:
establishing a feedback database configured to transmit and store feedback data related to a platform, wherein the feedback data comprises data related to a performance metric corresponding to one or more components of the platform;
analyzing the feedback data stored on the feedback database to identify a potential issue associated with the platform, wherein the potential issue is indicative of degradation of system performance;
identifying a source of the potential issue associated with the platform;
analyzing a first impact of performing an update to a first component of the platform related to the source of the potential issue;
analyzing a second impact of performing an update to a second component of the platform related to the first component of the platform;
generating a first update recommendation to update the first component of the platform based on a first result of analyzing the first impact of performing the update to the first component and a second result of analyzing the second impact of performing the update to the second component; and
performing, responsive to a determination that the first update recommendation comprises a non-disruptive impact to the second component, the first update recommendation to update the first component of the platform.

11. The computer program product of claim 10, wherein the program instructions are stored in a computer readable storage device in a data processing system, and wherein the stored program instructions are transferred over a network from a remote data processing system.

12. The computer program product of claim 10, wherein the program instructions are stored in a computer readable storage device in a server data processing system, and wherein the program instructions are downloaded in response to a request over a network to a remote data processing system for use in the computer readable storage device associated with the remote data processing system, further comprising:
program instructions to meter use of the program instructions associated with the request; and
program instructions to generate an invoice based on the metered use.

13. The computer program product of claim 10, wherein the operations further comprise:
generating a second update recommendation to update the second component of the platform based on results of analyzing the first impact of performing the update to the first component and results of analyzing the second impact of performing the update to the second component; and
performing the second update recommendation to update the second component of the platform.

14. The computer program product of claim 10, wherein the operations further comprise:
constructing a dependency mapping between a set of components of the platform, the dependency mapping defining a relationship between the first component and the second component.

15. The computer program product of claim 10, wherein the feedback data comprises user feedback data.

16. The computer program product of claim 10, wherein the feedback data comprises system feedback data.

17. A computer system comprising a processor and one or more computer readable storage media, and program instructions collectively stored on the one or more computer readable storage media, the program instructions executable by the processor to cause the processor to perform operations comprising:
establishing a feedback database configured to transmit and store feedback data related to a platform, wherein the feedback data comprises data related to a performance metric corresponding to one or more components of the platform;
analyzing the feedback data stored on the feedback database to identify a potential issue associated with the platform, wherein the potential issue is indicative of degradation of system performance;
identifying a source of the potential issue associated with the platform;
analyzing a first impact of performing an update to a first component of the platform related to the source of the potential issue;
analyzing a second impact of performing an update to a second component of the platform related to the first component of the platform;
generating a first update recommendation to update the first component of the platform based on a first result of analyzing the first impact of performing the update to the first component and a second result of analyzing the second impact of performing the update to the second component; and
performing, responsive to a determination that the first update recommendation comprises a non-disruptive impact to the second component, the first update recommendation to update the first component of the platform.

18. The computer system of claim 17, further comprising:
generating a second update recommendation to update the second component of the platform based on results of analyzing the first impact of performing the update to the first component and results of analyzing the second impact of performing the update to the second component; and
performing the second update recommendation to update the second component of the platform.

19. The computer system of claim 17, wherein the feedback data comprises user feedback data.

20. The computer system of claim 17, wherein the feedback data comprises system feedback data.
